(19) United States
(12) Patent Application Publication
(10) Pub. No.: US 2013/0228358 A1
(43) Pub. Date: Sep. 5, 2013

(54) MULTILAYER INSULATED WIRE

(71) Applicant: HITACHI CABLE, LTD., Tokyo (JP)

(72) Inventors: Kenichiro FUJIMOTO, Hitachi (JP); Hitoshi KIMURA, Hitachi (JP); Kiyoshi WATANABE, Hitachi (JP); Hiroshi NAKASHIMA, Hitachinaka (JP)

(73) Assignee: HITACHI CABLE, LTD., Tokyo (JP)

(21) Appl. No.: 13/783,614

(22) Filed: Mar. 4, 2013

(30) Foreign Application Priority Data
Mar. 5, 2012 (JP) 2012-047598
May 25, 2012 (JP) 2012-119164

(51) Int. Cl. H01B 7/29; H01B 7/295

(52) U.S. Cl. CPC H01B 7/292; H01B 7/295
USPC 174/110 SR

(57) ABSTRACT

A multilayer insulated wire includes a conductor, an inner layer coated on an outer periphery of the conductor, the inner layer comprising a resin compound containing 100 parts by weight of base polymer containing modified-poly(2,6-dimethylphenyleneether) as a main component, and 10 to 100 parts by weight of calcined clay as additive, and an outer layer coated on an outer periphery of the inner layer, the outer layer including a polyester resin compound including 100 parts by weight of base polymer containing polyester resin as a main component, and 50 to 150 parts by weight of polyester block copolymer, 0.5 to 3 parts by weight of hydrolysis inhibitor, and 10 to 30 parts by weight of magnesium hydroxide.

The present application is based on Japanese patent application No. 2012-047598 filed on Mar. 5, 2012 and Japanese patent application No. 2012-119164 filed on May 25, 2012, the entire contents of which are incorporated herein by reference.

### BACKGROUND OF THE INVENTION

1. Field of the Invention

The present invention relates to a multilayer insulated wire which is excellent in heat resistance, low smoke property, flame retardancy, abrasion resistance, hydrolysis resistance, and low toxicity, more particularly, to a multilayer insulated wire which is adapted to EN (European Norm, European Standards) standard.

2. Description of the Related Art

For rolling stock wires and cables for railway vehicles and mobile wires and cables to be used for cranes and the like, halogen-based rubber compounds having balanced oil resistance, fuel resistance, low-temperature property, flame resistance, flexibility, and cost, e.g., chloroprene rubber compound, chloro sulphonated polyethylene compound, chlorinated polyethylene compound, and fluorine rubber compound have been used.

However, the aforementioned materials containing a large amount of halogen will generate a large amount of toxic and harmful gas during its combustion, and may generate the extremely-poisonous dioxin depending on incineration conditions. Therefore, the use of the wires and cables using halogen-free materials that contain no halogen material as the coating material is expanding from the viewpoint of securing the fire-safety and reducing the environmental impact.

On the other hand, in Europe where the network of railways are well developed, the adoption of the region-unified standard called as “EN” (European Norm, European Standards) is expanding.

Since there is a risk of leading to serious accidents by defect of the wires and cables for railway vehicles, such wires and cables for railway vehicles are required in the EN to use halogen-free materials with the heat resistance, flame retardancy, hydrolysis resistance, abrasion resistance, and low smoke property.

To satisify these requirements, Japanese Patent Laid-Open No. 2011-228189 (JP-A 2011-228189) proposed a multilayer insulated wire which has inner and outer layers over the periphery of a conductor, the inner layer consisting of a polyester resin compound including a polyester resin, a polyester block copolymer, a hydrolysis inhibitor, and a calcined clay, the outer layer consisting of a polyester resin compound including a polyester resin, a polyester block copolymer, a hydrolysis inhibitor, a calcined clay, and magnesium hydroxide, in which the polyester block copolymer consists of: 20 to 70 mass % of a hard segment (A) containing polybutylene terephthalate containing not less than 60 mol % of terephthalic acid in dicarboxylic acid component as a main component; and 80 to 30% by mass of a soft segment (B) consisting of polyester containing 99 to 90 mol % of aromatic dicarboxylic acid as acid component constituting the polyester, 1 to 10 mol % of straight-chain aliphatic dicarboxylic acid with carbon number of 6 to 12 (6-12C), and a straight-chain diol of 6-12C as a diol component, in which a melting point (T) is within a range expressed by formula TO-5>T>TO-60 (TO: a melting point of the polymer consisting of components constituting the hard segment).

Although such a halogen-free insulated wire has excellent heat resistance, flame retardancy, hydrolysis resistance, abrasion resistance and low smoke property as desired, there is still a room for improvement.

### SUMMARY OF THE INVENTION

More concretely, in recent years, the wires and cables with excellent low toxicity in addition to the above properties has been required.

In the case of using a polybutylene naphthalate or polybutylene terephthalate layer as base polymer in both the inner and outer layers of the multilayer insulated wire as in the prior art (e.g. JP-A 2011-228189), it is impossible to achieve low toxicity.

It is necessary for the wires and cables for railway vehicles in Europe to satisfy the EN. The low toxicity however has not been carefully considered yet. The wires and cables for railway vehicles that satisfy all the properties required by the EN perfectly have not been achieved yet.

Accordingly, it is an object of the present invention to provide a halogen-free multilayer insulated wire which is excellent in heat resistance, low smoke property, flame retardancy, abrasion resistance, hydrolysis resistance, and low toxicity, more particularly, to a multilayer insulated wire which is adapted to the EN standard.

According to a feature of the invention, a multilayer insulated wire comprises:

a conductor;

an inner layer coated on an outer periphery of the conductor, the inner layer comprising a resin compound containing 100 parts by weight of base polymer containing modified-poly(2,6-dimethylphenyleneether) as a main component, and 10 to 100 parts by weight of calcined clay as additive; and

an outer layer coated on an outer periphery of the inner layer, the outer layer comprising a polyester resin compound comprising 100 parts by weight of base polymer containing polyester resin as a main component, and 50 to 150 parts by weight of polyester block copolymer, 0.5 to 3 parts by weight of hydrolysis inhibitor, and 10 to 30 parts by weight of magnesium hydroxide.

### EFFECTS OF THE INVENTION

According to the present invention, it is possible to provide a halogen-free multilayer insulated wire which is excellent in heat resistance, low smoke property, flame retardancy, abrasion resistance, hydrolysis resistance, and low toxicity, more particularly, to a multilayer insulated wire which is adapted to the EN standard.

### BRIEF DESCRIPTION OF THE DRAWINGS

Next, an embodiment according to the present invention will be explained below in conjunction with the appended drawings, wherein:

FIG. 1 is a cross-sectional view of a multilayer insulated wire in an embodiment according to the present invention;

FIG. 2A is a side view showing an abrasion tester for the multilayer insulated wire in the present invention;

FIG. 2B is another side view showing the abrasion tester for the multilayer insulated wire in the present invention; and

FIG. 3 is a schematic diagram for explaining an IEC combustion test method of the wire.

### DETAILED DESCRIPTION OF THE EMBODIMENT

Next, the embodiment of the present invention will be described below in more detail.

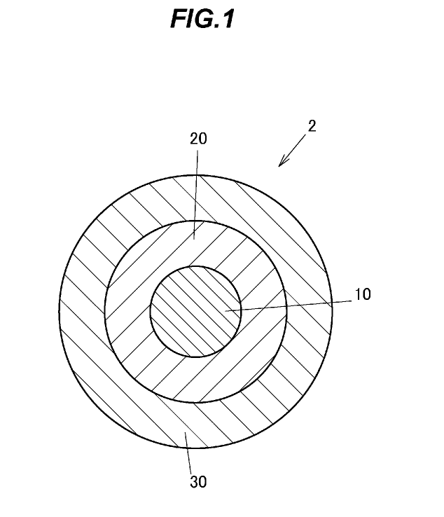

Referring to FIG. 1, a multilayer insulated wire 2 in the embodiment according to the invention comprises a conductor 10, an inner layer 20 coated on an outer periphery of the conductor 10, the inner layer 20 comprising a resin compound containing 100 parts by weight of base polymer containing modified-poly(2,6-dimethylphenyleneether) as a main component, and 10 to 100 parts by weight of calcined clay as an additive, and an outer layer 30 coated on an outer periphery of the inner layer 20, the outer layer 30 comprising a polyester resin compound comprising 100 parts by weight of base polymer containing polyester resin as a main component, and 50 to 150 parts by weight of polyester block copolymer, 0.5 to 3 parts by weight of hydrolysis inhibitor, and 10 to 30 parts by weight of magnesium hydroxide.

The inventors found that it is possible to provide the multilayer insulated wire with the low toxicity by using the modified-poly(2,6-dimethylphenyleneether) for the base polymer of the resin compound for the inner layer 20.

(Components of the Inner Layer)

Firstly, each component of the inner layer 20 will be described below.

As the base polymer of the inner layer 20, modified-poly(2,6-dimethylphenyleneether) (also called as “modified PPE”) is used as the main component.

The reason for using the modified-poly(2,6-dimethylphenyleneether) is as follows. The modified-poly(2,6-dimethylphenyleneether) has all of the electrical properties, low toxicity, and abrasion resistance and is a self-extinguishing type resin, so that the modified-poly(2,6-dimethylphenyleneether) can also contribute to the flame retardancy of the wires and cables.

The modified-poly(2,6-dimethylphenyleneether) is represented by Noryl (trademark) resin, and is preferably unfilled type resin.

Of course, the present invention does not preclude the use of a component other than the modified-poly(2,6-dimethylphenyleneether) in the base polymer as long as such a component does not impair the expression of the low toxicity in the present invention.

In the present invention, the calcined clay is added as an inorganic porous filler to the base polymer of the inner layer 20.

The reason for adding the calcined clay to the base polymer for the inner layer 20 is as follows. The electrical properties of the inner layer 20 can be improved by the addition of the calcined clay. On the other hand, if a large amount of the modified-poly(2,6-dimethylphenyleneether) is used, the multilayer insulated wire will not be accepted with a margin in terms of the low toxicity under the EN standard. Therefore, there is a purpose of diluting the component amount of the modified-poly(2,6-dimethylphenyleneether).

Further, the addition amount of the calcined clay is 10 to 100 parts by weight, preferably 60 to 90 parts by weight, more preferably 70 to 80 parts by weight relative to 100 parts by weight of the modified-poly(2,6-dimethylphenyleneether). If the content of the calcined clay is too small, the low toxicity of the multilayer insulated wire cannot be achieved. On the other hand, if the content of the calcined clay is too large, the moldability will be lowered unfavorably.

As described above, the calcined clay used in the present invention is the inorganic porous filler, and a specific surface area thereof is preferably not less than 5 m²/g.

The inorganic porous filler is not limited to the calcined clay, and zeolite, Mesalite (Mitsui Expanded Shale Light-Weight Aggregate), anthracite, perlite foam, or activated carbon may be used. Further, the inorganic porous filler may be a surface treatment such as silane treatment and fatty acid treatment.

(Components of the Outer Layer)

Next, each component of the outer layer 30 will be described below.

For the base polymer of the outer layer 30, polyester resin is used as the main component. The reason for using the polyester resin is because the polyester resin has excellent heat resistance and abrasion resistance.

For example, polybutylene terephthalate (PBT) resin, polytrimethylene terephthalate resin, polyethylene naphthalate resin, polyethylene terephthalate resin, polybutylene naphthalate (PBN) resin or the like may be used as the polyester resin. Further, as long as the effect of the present invention is not impaired, a combination of the above polyester resins may be used. Further, the above polyester resins may be used by mixing with polypropylene resin, polyethylene resin or the like.

In the present invention, the polybutylene terephthalate resin (PBT) is a polyester comprising naphthalene dicarboxylic acid, preferably naphthalene-2,6-dicarboxylic acid as a main acid component, and 1,4-butadiol as a main glycol component, namely, entire part or major part (usually not less than 90 mol %, preferably not less than 95 mol %) of the repeating units in the polyester is polybutylene naphthalene dicarboxylate.

Further, as long as the physical properties are not deteriorated, the polyester can be copolymerized with following components.

As the acid component, aromatic dicarboxylic acids other than naphthalene dicarboxylic acid such as phthalic acid, isophthalic acid, terephthalic acid, diphenyl dicarboxylic acid, diphenylether dicarboxylic acid, diphenoxyethane dicarboxylic acid, diphenylmethane dicarboxylic acid, diphenylketone dicarboxylic acid, diphenyl sulfide dicarboxylic acid, diphenyl sulfone dicarboxylic acid, aliphatic dicarboxylic acids such as succinic acid, adipic acid, sebacic acid, and alicyclic dicarboxylic acids such as cyclohexane dicarboxylic acid, tetralindicarboxylic acid, decalindicarboxylic acid and the like may be exemplified.

As the glycol component, ethylene glycol, propylene glycol, trimethylene glycol, pentamethylene glycol, hexamethylene glycol, octamethylene glycol, neopentyl glycol, cyclohexanedimethanol, xylylene glycol, diethylene glycol, polyethylene glycol, bisphenol A, catechol, resorcinol, hydroquinone, dihydroxydiphenyl, dihydroxydiphenylether, dihydroxy diphenylmethane, dihydroxy diphenylketone, dihydroxy diphenylsulfide, dihydroxydiphenyl sulfone and the like may be exemplified.

As the oxycarboxylic acid component, hydroxybenzoic acid, hydroxy-naphthoic acid, hydroxydiphenyl carboxylic acid, ω-hydroxycaproic acid and the like may be exemplified.

In addition, as long as the polyester does not substantially lose the molding property, the polyester may be copolymerized with a compound having three or more functional groups, e.g., glycerol, trimethyl propane, pentaerythritol, trimellitic acid, pyromellitic acid and the like.

Such polyester is obtained from polycondensation of naphthalene dicarboxylic acid and/or a functional derivative thereof and butylene glycol and/or a functional derivative thereof with using the known methods for producing aromatic polyester.

A concentration of the terminal carboxyl group of the PBN to be used in the present invention is not particularly limited. It is however preferable that the concentration of the terminal carboxyl group of the PBN is low.

The polybutylene terephthalate resin as the polyester resin used in the present invention is a polyester comprising butylene terephthalate repeating units as a main component, more particularly, comprising butylene terephthalate units as a main repeating unit, in which the butylene terephthalate unit is obtained from 1,4-butanediol as polyhydric alcohol component and terephthalic acid or its ester-forming derivative as polycarboxylic acid component. Here, the “main repeating unit” means that the butylene terephthalate unit is not less than 70 mol % of total polycarboxylic acid-polyhydric alcohol units. The butylene terephthalate unit is preferably not less than 80 mol %, more preferably not less than 90 mol %, and particularly preferably not less than 95 mol %.

As the polycarboxylic acid component other than terephthalic acid used in the polybutylene terephthalate resin, aromatic polycarboxylic trimesic acids such as 2,6-naphthalene dicarboxylic acid, 2,7-naphthalene dicarboxylic acid, isophthalic acid, phthalic acid, trimesic acid, trimellitic acid and the like, aliphatic dicarboxylic acids such as oxalic acid, malonic acid, succinic acid, glutaric acid, adipic acid, suberic acid, azelaic acid, sebacic acid, decanedicarboxylic acid and the like, alicyclic dicarboxylic acids such as cyclohexane dicarboxylic acid and the like, and ester-forming derivatives of the above polycarboxylic acids (e.g. lower alkyl esters of polycarboxylic acids such as dimethyl terephthalate) may be exemplified. The above polycarboxylic acids may be used alone or as a mixture of plural components.

On the other hand, as the polyhydric alcohol component other than 1,4-butanediol, aliphatic polyhydric alcohols such as ethylene glycol, diethylene glycol, propylene glycol, neopentyl glycol, pentanediol, hexanediol, glycerol, trimethylolpropane, pentaerythritol, alicyclic polyhydric alcohols such as 1,4-cyclohexane dimethanol, aromatic polyhydric alcohols such as bisphenol A, bisphenol Z, and polyalkylene glycols such as polyethylene glycol, polypropylene glycol, polytetramethylene glycol, polytetramethylene oxide glycol, and the like may be exemplified. These polyhydric alcohol components may be used alone or in plural.

In the polybutylene terephthalate resin used in the present invention, the terminal carboxyl group equivalent is not more than 50 (eq/T), preferably not more than 40 (eq/T), and more preferably not more than 30 (eq/T) from the viewpoint of hydrolysis resistance. The terminal carboxyl group equivalent exceeding 50 (eq/T) is not favorable in view of the hydrolysis resistance.

As long as the requirements of the present invention are satisfied, the polybutylene terephthalate resin of the present invention may be used alone or a mixture of a plurality of polybutylene terephthalate resins having different terminal carboxyl group concentrations, melting points, catalytic amounts, or the like may be used.

The polyester block copolymer is added to the base polymer for the outer layer 30 of the present invention. The reason for adding the polyester block copolymer is for further enhancing the heat resistance and for providing the flexibility. The additive amount of the polyester block copolymer should be within the range of not less than 50 parts by weight and not more than 150 parts by weight relative to 100 parts by weight of the base polymer. If the additive amount of the polyester block copolymer is less than 50 parts by weight, the desired flexibility will not be achieved. On the other hand, if the additive amount of the polyester block copolymer exceeds 150 parts by weight, the low toxicity and the abrasion resistance will be insufficient.

In the polyester block copolymer used in the present invention, hard segment contains polybutylene terephthalate containing not less than 60 mol % of polybutylene terephthalate as a main component, and may be copolymerized with aromatic dicarboxylic acids containing benzene or naphthalene ring other than terephthalic acid, aliphatic dicarboxylic acids with carbon number of 4 to 12, and diols such as aliphatic diol with carbon number of 2 to 12 other than tetramethylene glycol, alicyclic diols such as cyclohexanedimethanol. Here, a copolymerization ratio thereof is preferably less than 30 mol %, preferably less than 10 mol %, per total dicarboxylic acids.

On the other hand, as soft segment, polyester comprising 99 to 90 mol % of aromatic dicarboxylic acid, 1 to 10 mol % of straight-chain aliphatic dicarboxylic acid with carbon number of 6 to 12, and straight-chain diol with carbon number of 6 to 12 as diol component is used. As the aromatic dicarboxylic acid, terephthalic acid and isophthalic acid may be used. As the straight-chain aliphatic dicarboxylic acid with carbon number of 6 to 12, adipic acid, sebacic acid and the like may be used. The amount of the straight-chain aliphatic dicarboxylic acid is 1 to 10 mol %, preferably 2 to 5 mol % per total acid components of the polyester constituting the soft segment. If the amount of the straight-chain aliphatic dicarboxylic acid exceeds 10 mol %, the compatibility with the polybutylene naphthalate resin and the abrasion resistance will be lowered. On the other hand, if the amount of the straight-chain aliphatic dicarboxylic acid is less than 1 mol %, the softness of the soft segment will be lowered so that the softness of the polyester resin compound will be deteriorated. As the diol component, the straight-chain diol with carbon number of 6 to 12 is used. The polyester constituting the soft segment must be amorphous or low crystalline. It is therefore preferred to use not less than 20 mol % of isophthalic acid relative to total acid components constituting the soft segment. Similarly to the hard segment, the soft segment may be obtained by copolymerizing with a not significant amount of other components. However, if the amount of copolymer components is too large, the compatibility with the polybutylene naphthalate resin and the abrasion resistance that are the object of the present invention will be deteriorated. Therefore, the amount of the copolymer components is not more than 10 mol %, preferably not more than 5 mol %. In the polyester block copolymer of the present invention, the ratio of the hard segment and the soft segment is preferably 20 to 50 versus 80 to 50, preferably 25 to 40 versus 75 to 60. The amount ratio is determined as follows. If the ratio of the hard segment exceeds the aforementioned range, the obtained polyester block copolymer becomes harder and difficult to be used. If the ratio of the soft segment exceeds the aforementioned range, the obtained polyester block copolymer will be provided with less crystalline property, and difficult to be handled.

The segment lengths of the soft segment and the hard segment of the polyester block copolymer are respectively around 500 to 7000, and preferably 800 to 5000, as expressed in molecular weight. However, the present invention is not limited thereto. Although the direct measurement of the segment length is difficult, the segment length may be estimated, for example, by using Flory formula based on the composition of the polyester constituting each of the soft segment and the hard segment, the melting point of the polyester constituting the hard segment, and the melting point of the obtained polyester block copolymer.

From this viewpoint, the melting point of the polyester block copolymer of the present invention is important. The melting point (T) of the polyester block copolymer of the present invention is preferably within the range expressed by following formula (I):

TO-5>T>TO-60 (1),

wherein TO is the melting point of the polymer consisting of the components constituting the hard segment.

In other words, the melting point (T) is between the TO-5 and TO-60, preferably between TO-10 and TO-50, more preferably between TO-15 and TO-40. Further, the melting point (T) of the polyester block copolymer of the present invention is higher by 10 degrees Celsius, preferably by not less than 20 degrees Celsius than a melting point (T′) of a random copolymer of the same components. In the case that the melting point (T′) of the random copolymer of the same polyester cannot be determined, the melting point (T) of the polyester block copolymer is not less than 150 degrees Celsius, preferably not less than 160 degrees Celsius.

In the present invention, the block copolymer is used rather than the random copolymer, since the random copolymer is generally amorphous and a glass transition temperature thereof is low, so that the random copolymer is in the form of syrup. The moldability of the polyester random copolymer is significantly low and has a sticky surface, so that the polyester random copolymer cannot be used for practical purpose.

As the method for manufacturing a polyester block copolymer as described above, a technique of forming a polymer constituting the hard segment and a polymer constituting the soft segment, and melt-mixing both polymers to provide a mixed polymer with a melting point lower than a melting point of the polyester constituting the hard segment. This melting point varies depending on the mixing temperature and the mixing time. Therefore, it is preferable to deactivate the catalyst by adding a catalyst deactivator such as phosphorus oxyacid at the timing of achieving the state showing a target melting point.

In the polyester block copolymer of the present invention, the intrinsic viscosity measured in orthochlorophenol at a temperature of 35 degrees Celsius is not less than 0.6, preferably from 0.8 to 1.5. If the intrinsic viscosity is lower than the above range, the strength of the polyester block copolymer will be unfavorably lowered.

The hydrolysis inhibitor is added to the base polymer for the outer layer 30 of the present invention.

The hydrolysis inhibitor to be used in the present invention is an additive agent comprising a compound having a carbodiimide skeleton such as dicyclohexyl carbodiimide, diisopropyl carbodiimide, 1-ethyl-3-(3-dimethylaminopropyl)carbodiimide hydrochloride. The present invention is not limited thereto. The additive amount of the hydrolysis inhibitor is 0.5 to 3 parts by weight, preferably 1 to 2 parts by weight relative to the polybutylene naphthalate resin compound. If the additive amount thereof is less than 0.5 parts by weight, the hydrolysis resistance of the present invention will not be exhibited enough. If the additive amount thereof exceeds 3 parts by weight, the low toxicity will not be achieved.

In the present invention, it is preferable to add calcined clay to the base polymer for the outer layer 30. The reason for adding the calcined clay is to further improve the electrical properties of the outer layer 30.

Further, the additive amount of the calcined clay to the polyester resin compound is preferably 0.5 to 5 parts by weight, more preferably 1 to 3 parts by weight. If the content of the calcined clay is too small, the ions cannot be trapped enough so that the insulation resistance will decreases and the electrical properties will be deteriorated. On the other hand, if the content of the calcined clay is too large, the abrasion resistance will be unfavorably reduced.

The calcined clay to be added to the outer layer 30 may be the same as the calcined clay to be added to the inner layer 20.

In the present invention, magnesium hydroxide is added to the outer layer 30. The reason for adding the magnesium hydroxide is to improve the flame retardancy and to provide the outer layer 30 with the low smoke property. The additive amount of the magnesium hydroxide relative to 100 parts by weight of the base polymer should be within the range of 10 to 30 parts by weight. If the additive amount of the magnesium hydroxide is less than 10 parts by weight, the low smoke property will be insufficient. On the other hand, if the additive amount of the magnesium hydroxide exceeds 30 parts by weight, the hydrolysis resistance will be deteriorated.

The magnesium hydroxide to be used in the present invention is not particularly limited. The magnesium hydroxide may be surface treated by fatty acid, metal salt of fatty acids, vinyl trimethoxysilane, vinyltriethoxyethyl silane, methacryloxypropyl trimethoxy silane, methacryloxypropyl triethoxy silane, aminopropyltrimethoxysilane, aminopropyltriethoxysilane, or the like. The magnesium hydroxide with no surface treatment may be also used.

The additive amount of the magnesium hydroxide relative to 100 parts by weight of the polyester resin compound is 10 to 30 parts by weight, preferably 15 to 20 parts by weight. If the additive amount of the magnesium hydroxide is less than 10 parts by weight, the flame retardancy and the low smoke property will be insufficient. On the other hand, if the additive amount of the magnesium hydroxide exceeds 30 parts by weight, the flexibility and the abrasion resistance when processed into the wire or cable will be deteriorated.

The method of compounding the above-described various components in the modified-poly(2,6-dimethylphenyleneether) resin and the polyester resin can be performed by any well-known means at an arbitrary stage of production just before the coating. As the most convenient methods, the method of conducting melt mixing extrusion on the calcined clay and the like added to the modified-poly(2,6-dimethylphenyleneether) into pellets, and the method of conducting melt mixing extrusion on the polyester-polyester elastomer, hydrolysis inhibitor, calcined clay, magnesium hydroxide and the like added to the polyester resin into pellets may be adopted.

As long as the effects of the present invention are provided, pigments, dyes, fillers, nucleating agents, mold release agents, antioxidants, stabilizers, antistats, lubricants, or other known additives may be blended and kneaded into the resin compound used for the inner and outer layers 20, 30 of the present invention.

(Method for Producing the Multilayer Insulated Wire)

In the method for producing the multilayer insulated wire 2 of the present invention, the extrusion coating steps of the resin compound for the inner layer 20 and the resin compound for the outer layer 30 may be performed at separate stages. Alternatively, the extrusion coating steps of the inner layer 20 and the outer layer 30 may be performed at the same time. Further, the resin compound may be cross-linked by irradiating the multilayer insulated wire 2 produced by the extrusion coating as necessity.

(Variations)

As long as the multilayer insulated wire 2 comprises the inner layer 20 and the outer layer 30, the number of the layers is not limited to two. The multilayer insulated wire 2 may further comprise an insulative layer between the conductor 10 and the inner layer 20. The multilayer insulated wire 2 may further comprise an intermediate layer between the inner layer 20 and the outer layer 30.

### EXAMPLES

The present invention will be described in more detail by the following Examples and Comparative Examples. The present invention is however not limited only to these examples of the present invention.

The multilayer insulated wires in Examples 1 to 8, Comparative Examples 1 to 8, and prior art 1 were manufactured as follows.

Table 1 shows the blending composition of the resin compound of the inner layer and the resin compound of the outer layer that were studied in the present invention. Table 2 shows the evaluation results of the samples based on various blending components.

TABLE 1

| | Blending composition (parts by weight) | | | | | | | | | | | | | | | |
|---|---|---|---|---|---|---|---|---|---|---|---|---|---|---|---|---|
| | Polyester resin compound (A) | | | | | | | | | | Polyester resin compound (B) | | | | | |
| | [Inner layer] | | | | | | | | | | [Outer layer] | | | | | |
| | A1 | A2 | A3 | A4 | A5 | A6 | A7 | A8 | A9 | A10 | B1 | B2 | B3 | B4 | B5 | B6 |
| Example 1 | 100 | — | — | — | 50 | 10 | — | — | 1 | 1.5 | 100 | — | 66.7 | 1 | 1 | 20 |
| Example 2 | 100 | — | — | — | 80 | 10 | — | — | 1 | 1.5 | 100 | — | 66.7 | 1 | 1 | 10 |
| Example 3 | 100 | — | — | — | 80 | 10 | — | — | 1 | 1.5 | 100 | — | 66.7 | 1 | 1 | 20 |
| Example 4 | 100 | — | — | — | 80 | 10 | — | — | 1 | 1.5 | 100 | — | 66.7 | 1 | 1 | 30 |
| Example 5 | 100 | — | — | — | 80 | 10 | — | — | 1 | 1.5 | — | 100 | 66.7 | 1 | 1 | 20 |
| Example 6 | 100 | — | — | — | 100 | 10 | — | — | 1 | 1.5 | 100 | — | 66.7 | 1 | 1 | 20 |
| Example 7 | 100 | — | — | — | 10 | 10 | — | — | 1 | 1.5 | 100 | — | 66.7 | 1 | 1 | 20 |
| Example 8 | 100 | — | — | — | 50 | 10 | — | — | 1 | 1.5 | 100 | — | 66.7 | 1 | 1 | 20 |
| Comparative | 100 | — | — | — | 5 | 10 | — | — | 1 | 1.5 | 100 | — | 66.7 | 1 | 1 | 20 |
| Example 1 | | | | | | | | | | | | | | | | |
| Comparative | 100 | — | — | — | 120 | 10 | — | — | 1 | 1.5 | 100 | — | 66.7 | 1 | 1 | 20 |
| Example 2 | | | | | | | | | | | | | | | | |
| Comparative | 100 | — | — | — | 80 | 10 | — | — | 1 | 1.5 | 100 | — | 66.7 | 1 | 1 | 20 |
| Example 3 | | | | | | | | | | | | | | | | |
| Comparative | — | 100 | — | — | — | 10 | 100 | — | 1 | 1.5 | 100 | — | 66.7 | 5 | 1 | 20 |
| Example 4 | | | | | | | | | | | | | | | | |
| Comparative | 100 | — | — | — | 50 | 10 | — | — | 1 | 1.5 | 100 | — | 30 | 1 | 1 | 20 |
| Example 5 | | | | | | | | | | | | | | | | |
| Comparative | 100 | — | — | — | 80 | 10 | — | — | 1 | 1.5 | 100 | — | 180 | 1 | 1 | 20 |
| Example 6 | | | | | | | | | | | | | | | | |
| Comparative | 100 | — | — | — | 80 | 10 | — | — | 1 | 1.5 | 100 | — | 66.7 | 1 | 1 | 5 |
| Example 7 | | | | | | | | | | | | | | | | |
| Comparative | 100 | — | — | — | 80 | 10 | — | — | 1 | 1.5 | 100 | — | 66.7 | 1 | 1 | 50 |
| Example 8 | | | | | | | | | | | | | | | | |
| Prior art 1 | — | — | 100 | 82 | 1 | — | — | 3 | — | — | 100 | — | 66.7 | 1 | 1 | 20 |

A1: Modified PPE resin (“WCV-063-111” manufactured by Saudi Basic Industries Corporation (SABIC))
A2: Ethylene vinyl acetate (EVA) (“Evaflex EV260” manufactured by Du-Pont Mitsui Polychemicals, Co., Ltd.)
A3: PBN (“TQB-OT” manufactured by Teijin Chemicals Ltd.)
A4: Polyester block copolymer (“Nuberan TRB-EL2” manufactured by Teijin Chemicals Ltd.)
A5: Calcined clay 1 (“TRANSLINK 77” manufactured by BASF)
A6: Titanium oxide (“R-820” manufactured by Ishihara Sangyo Co., Ltd.)
A7: Magnesium hydroxide (“Kisuma 5L” manufactured by Kyowa Chemical Industry Co., Ltd.)
A8: Hydrolysis inhibitor (“Carbodilite HMV-8CA” manufactured by Nisshinbo Industries, Inc.)
A9: Trimethylolpropane methacrylate (“NK ester TMPT (H-200)” manufactured by Shin-Nakamura Chemical Co., Ltd.)
A10: Antioxidant (“Adekastab AO-18” manufactured by Adeka Corporation)
B1: PBN (“TQB-OT” manufactured by Teijin Chemicals Ltd.)
B2: PBT (“NOVADURAN 5026” manufactured by Mitsubishi Engineering-Plastics Corporation)
B3: Polyester block copolymer (“Nuberan TRB-EL2” manufactured by Teijin Chemicals Ltd.)
B4: Hydrolysis inhibitor (“Carbodilite HMV-8CA” manufactured by Nisshinbo Industries, Inc.)
B5: Calcined clay 2 (“SP-33” manufactured by Engelhard Corporation)
B6: Magnesium hydroxide (“Kisuma 5L” manufactured by Kyowa Chemical Industry Co., Ltd.)

(Manufacture of the Multilayer Insulated Wire)

The samples of the multilayer insulated wires in the Examples, Comparative examples and Prior art as shown in TABLE 1 were manufactured as follows. The obtained resin compound (A) and the resin compound (B) were dried in a hot blast thermostat vessel at 80 degrees Celsius for 8 hours or more and 120 degrees Celsius for 8 hours or more, respectively, then the resin compound (A) was extrusion-molded with a coating thickness of 0.15 mm as an inner layer directly around a tin plated annealed copper wire having a diameter of 1.2 mm. Further, the resin compound (B) was extrusion-molded with a coating thickness of 0.10 mm as an outer layer around the inner layer. In the extrusion molding, a dice having a diameter of 4.2 mm and a nipple having a diameter of 2.0 mm were used, and an extrusion temperature was set to be 220 degrees Celsius to 270 degrees Celsius at a cylinder part, and set to be 265 degrees Celsius at a head part. A drawing speed was set to be 10 m/minute.

Evaluation of the abrasion resistance, DC stability (electrical property), low toxicity, flexibility, hydrolysis resistance, low smoke property was performed as follows.

(Abrasion Resistance Test)

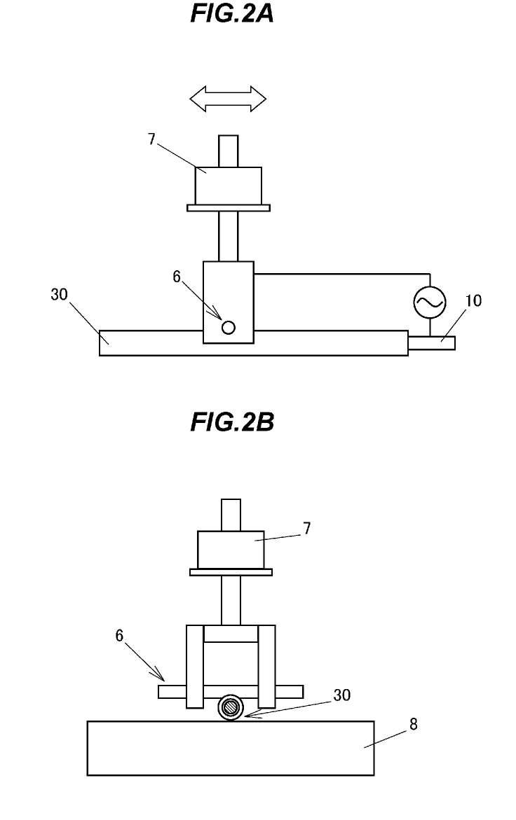

The prepared multilayer insulated wire was placed in an atmosphere of a normal temperature, and reciprocal motion of the abrasion test machine as shown in FIGS. 2A and 2B was performed under a load of 9N, and the number of times of the reciprocal motion was measured until short circuit was generated.

The prepared multilayer electric wire 2 was placed in an atmosphere of a normal temperature on a support 8, and a tip end 6 of the abrasion test machine was brought into contact with an outer layer 30 of the conductor 10, while adding a load 7 to the outer layer 30, then reciprocal motion of the abrasion test machine was performed, and the numbers of times of the reciprocal motion were measured until short circuit was generated by contact of the tip end 6 with the conductor 10.

The reciprocal motion of 150 numbers of times was defined as “o (acceptable)”, and the reciprocal motion of fewer than 150 numbers of times was defined as “x (not acceptable)”.

(DC Stability Test)

According to EN50305.6.7, the prepared multilayer insulated wire was charged at DC 300V in 3% NaCl aqueous solution at 85 degrees for 10 days. The sample with no occurrence of the insulation breakdown was defined as “o (acceptable)”, and the sample with occurrence of the insulation breakdown was defined as “x (not acceptable)”.

(Toxicity Test)

According to EN50305.6.7, the conductor was extracted from the prepared multilayer insulated wire and the remained inner and outer layers were sliced into rings to provide test pieces. 1 g of the test pieces were combusted at 800 degrees Celsius. Quantitative analysis was performed on five kinds of gases (CO, CO₂, HCN, SO₂, NOx) generated by the combustion of the sample, and the analysis results were converted by predetermined weighting the type into conventional toxic index (ITC value) for evaluation. The sample with the ITC value of not more than 6 was defined as “o (acceptable)”, and the sample with the ITC value exceeding 6 was defined as “x (not acceptable)”.

(Hydrolysis Resistance Test)

The sample after extracting the conductor of the prepared multilayer insulated wire is allowed to stand for 30 days in a thermohygrostat vessel, with a temperature set to be 85 degrees Celsius and humidity set to be 85% RH. Then, a self-diameter winding test was conducted. The sample with no occurrence of cracks was defined as “o (acceptable)”, and the sample with occurrence of cracks was defined as “x (not acceptable)”.

(Flame Retardancy Test)

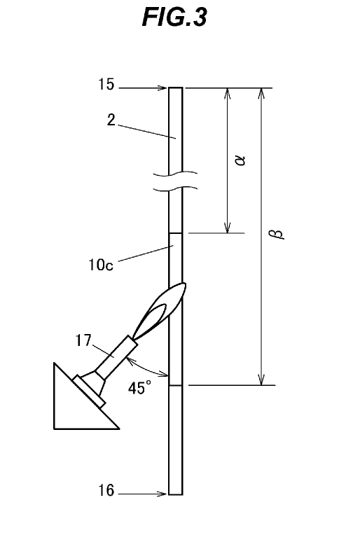

The flame retardancy was measured by a combustion test. The prepared multilayer insulated wire was tested, pursuant to an IEC combustion test method (IEC 60332-1). As shown in FIG. 3, the multilayer insulated wire 2 was vertically held by an upper support part 15 and a lower support part 16, then the multilayer insulated wire 2 was exposed to a flame of a burner 17 at a position of 475+−5 mm from the upper support part 15 and at an angle of 45 degrees for a defined burning time, and thereafter the burner 17 was removed, the flame was extinguished, and a carbonized part 10c of the multilayer insulated wire 2 was checked.

The sample in which a distance a from the upper support part 15 to an upper end of the carbonized part 10c is not less than 50 mm and a distance 13 from the upper support part 15 to a lower end of the carbonized part 10c is not more than 540 mm was defined as “o (acceptable)”, and the sample in which the distances α and β do not fall within the above ranges was defined as “x (not acceptable)”.

(Smoke Emitting Concentration Test)

According to EN50268.2, variation in the transmissivity due to smoke generated by the combustion of the multilayer insulated wire was measured. The sample with the transmissivity of not less than 70% was defined as “o (acceptable)”, and the sample with the transmissivity below 70% was defined as “x (not acceptable)”.

(Flexibility Test)

According to EN50305.5.4, a load was applied to the multilayer insulated wire by the defined weight. The sample with a hanging angle of not more than 45 degrees was defined as “o (acceptable)”, and the sample with a hanging angle exceeding 45 degrees was defined as “x (not acceptable)”.

TABLE 2

| | Abrasion | DC | Low | | Hydrolysis | Low | Flame | Total |
|---|---|---|---|---|---|---|---|---|
| | resistance | stability | toxicity | Flexibility | resistance | smoke | retardancy | Evaluation |
| Example 1 | ∘ | ∘ | ∘ | ∘ | ∘ | ∘ | ∘ | Acceptable |
| Example 2 | ∘ | ∘ | ∘ | ∘ | ∘ | ∘ | ∘ | Acceptable |
| Example 3 | ∘ | ∘ | ∘ | ∘ | ∘ | ∘ | ∘ | Acceptable |
| Example 4 | ∘ | ∘ | ∘ | ∘ | ∘ | ∘ | ∘ | Acceptable |
| Example 5 | ∘ | ∘ | ∘ | ∘ | ∘ | ∘ | ∘ | Acceptable |
| Example 6 | ∘ | ∘ | ∘ | ∘ | ∘ | ∘ | ∘ | Acceptable |
| Example 7 | ∘ | ∘ | ∘ | ∘ | ∘ | ∘ | ∘ | Acceptable |
| Example 8 | ∘ | ∘ | ∘ | ∘ | ∘ | ∘ | ∘ | Acceptable |
| Comparative | ∘ | ∘ | x | ∘ | ∘ | ∘ | ∘ | Not |
| Example 1 | | | | | | | | acceptable |
| Comparative | Inner layer was not moldable | | | — | — | — | — | Not |
| Example 2 | | | | | | | | acceptable |
| Comparative | ∘ | ∘ | x | ∘ | ∘ | ∘ | ∘ | Not |
| Example 3 | | | | | | | | acceptable |
| Comparative | x | x | ∘ | ∘ | ∘ | ∘ | ∘ | Not |
| Example 4 | | | | | | | | acceptable |
| Comparative | ∘ | ∘ | ∘ | x | ∘ | ∘ | ∘ | Not |
| Example 5 | | | | | | | | acceptable |
| Comparative | x | ∘ | x | ∘ | ∘ | ∘ | ∘ | Not |
| Example 6 | | | | | | | | acceptable |
| Comparative | ∘ | ∘ | ∘ | ∘ | ∘ | x | ∘ | Not |
| Example 7 | | | | | | | | acceptable |
| Comparative | ∘ | ∘ | ∘ | ∘ | x | ∘ | ∘ | Not |
| Example 8 | | | | | | | | acceptable |
| Prior art 1 | ∘ | ∘ | x | ∘ | ∘ | ∘ | ∘ | Not |
| | | | | | | | | acceptable |

∘: acceptable,
x: not acceptable

From TABLE 2, it is clearly understood that all of the samples in Examples 1 to 8 are acceptable under the toxicity test and excellent in the abrasion resistance, DC stability (electrical property), flexibility, hydrolysis resistance, and low smoke property.

On the other hand, in Comparative Example 1 in which the additive amount of the calcined clay 1 in the inner layer is smaller than the specified range of the present invention, the low toxicity is unacceptable. In Comparative Example 2 in which the additive amount of the calcined clay 1 in the inner layer is greater than the specified range of the present invention, the inner layer is not moldable and cannot be evaluated. In Comparative Example 3 in which the additive amount of the hydrolysis inhibitor in the outer layer is greater than the specified range of the present invention, the low toxicity is not acceptable. In Comparative Example 4 in which ethylene vinyl acetate (EVA) copolymer is used as the base polymer of the inner layer and the magnesium hydroxide is used as the flame retardant, the abrasion resistance and the DC stability are not acceptable.

In Comparative Example 5 in which the additive amount of the polyester block copolymer in the outer layer is smaller than the specified range of the present invention, the flexibility is unacceptable. In Comparative Example 6 in which the additive amount of the polyester block copolymer in the outer layer is greater than the specified range of the present invention, the abrasion resistance and the low toxicity are not acceptable. In Comparative Example 7 in which the additive amount of the magnesium hydroxide in the outer layer is smaller than the specified range of the present invention, the low smoke property is not acceptable. In Comparative Example 8 in which the additive amount of the magnesium hydroxide in the outer layer is greater than the specified range of the present invention, the hydrolysis resistance is not acceptable.

In prior art in which the base polymers of the inner and outer layers are polybutylene naphthalate (PBN), the low toxicity is not acceptable.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A multilayer insulated wire comprising:
a conductor;
an inner layer coated on an outer periphery of the conductor, the inner layer comprising a resin compound containing 100 parts by weight of base polymer containing modified-poly(2,6-dimethylphenyleneether) as a main component, and 10 to 100 parts by weight of calcined clay as additive; and
an outer layer coated on an outer periphery of the inner layer, the outer layer comprising a polyester resin compound comprising 100 parts by weight of base polymer containing polyester resin as a main component, and 50 to 150 parts by weight of polyester block copolymer, 0.5 to 3 parts by weight of hydrolysis inhibitor, and 10 to 30 parts by weight of magnesium hydroxide.

2. The multilayer insulated wire according to claim 1, wherein the base polymer containing the polyester resin comprises polyethylene terephthalate or polybutylene naphthalate.

3. The multilayer insulated wire according to claim 1, wherein the hydrolysis inhibitor comprises an additive comprising having a carbodiimide skeleton.

4. The multilayer insulated wire according to claim 2, wherein the hydrolysis inhibitor comprises an additive comprising having a carbodiimide skeleton.
